(19) United States
(12) Patent Application Publication
(10) Pub. No.: US 2026/0310160 A1
(43) Pub. Date: Oct. 8, 2026

(54) DISPLAY DEVICE FOR MACHINE TOOL

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 19/481,827

(22) PCT Filed: May 11, 2023
(86) PCT No.: PCT/JP2023/017816

§ 371 Date: Nov. 5, 2025

(51) Int. Cl. G05B 19/4065; G05B 19/416

(52) U.S. Cl. CPC G05B 19/4065; G05B 19/416

(57) ABSTRACT

Provided is a technology with which it is possible to understanding the degree of a problem caused by a return operation in rocking processing in a machine tool. A display device 1 for a machine tool includes: a processing condition acquisition unit 11 that acquires at least a frequency parameter and an amplitude parameter as processing conditions for performing rocking processing; a speed calculation unit 12 that calculates, on the basis of at least the frequency parameter and the amplitude parameter, the minimum feed speed which is the minimum among speeds changed by rocking operation; and a display control unit 15 that displays, on a display unit 20, an image based on the minimum feed speed.

### TECHNICAL FIELD

The present invention relates to a display device for a machine tool.

### BACKGROUND ART

There is a known technique for displaying various parameters, such as a feed speed and the like, in order to allow for setting machining conditions for a machine tool that performs oscillation machining in which a tool is oscillated with respect to a workpiece so that chips are shredded (for example, Patent Document 1).

### CITATION LIST

### Patent Document

Patent Document 1: Japanese Unexamined Patent Application, Publication No. 2023-000009

### DISCLOSURE OF THE INVENTION

### Problems to be Solved by the Invention

In the oscillation machining, oscillation motion is superimposed on ordinary cutting motion, whereby the feed speed fluctuates constantly. When an operator cannot grasp the maximum speed for forward motion, the operator cannot appropriately select a tool or appropriately set parameters for the oscillation machining. In this regard, according to the technique disclosed in Patent Document 1, the maximum speed for the oscillation motion is displayed, allowing the operator to check the maximum speed.

Incidentally, when return motion occurs in oscillation, the minimum speed becomes negative. Consequently, fretting wear may occur, or backlash may lower positional accuracy and cause an impact. It is difficult to grasp these problems caused by the return motion only by way of display of the maximum speed.

The present disclosure has been achieved in view of the above-described problems, and an object of the present disclosure is to provide a technique that allows an operator to grasp a degree of problem caused by return motion in oscillation machining performed by a machine tool.

### Means for Solving the Problems

The present disclosure provides a display device for a machine tool that performs oscillation machining while relatively oscillating a cutting tool and a workpiece, the display device including: a machining condition acquisition unit that acquires at least a frequency parameter and an amplitude parameter as machining conditions for performing the oscillation machining; a speed calculation unit that calculates a minimum feed speed that is a minimum included in a speed that changes due to oscillation motion, based on at least the frequency parameter and the amplitude parameter; and a display control unit that displays, on a display unit, an image based on the minimum feed speed.

### BRIEF DESCRIPTION OF THE DRAWINGS

FIG. 1 is a functional block diagram illustrating a display device for a machine tool according to a first embodiment;

FIG. 2 is a flowchart illustrating an example of a flow of a process of display control performed by the display device according to the first embodiment;

FIG. 3 is a diagram illustrating an example of an image displayed on a display unit by the display device and showing a minimum feed speed and a maximum feed speed based on an oscillation frequency and an oscillation amplitude;

FIG. 4 is a diagram illustrating an example of an image displayed on the display unit by the display device and showing a minimum feed speed and a maximum feed speed based on an oscillation frequency multiplying factor and an oscillation amplitude multiplying factor;

FIG. 5 is a flowchart illustrating an example of a flow of a process of display control performed by a display device according to a second embodiment;

FIG. 6 is a diagram illustrating an example of an image displayed on a display unit by the display device and showing an oscillation component speed based on an oscillation frequency and an oscillation amplitude; and

FIG. 7 is a diagram illustrating an example of an image displayed on the display unit by the display device and showing an oscillation component speed based on an oscillation frequency multiplying factor and an oscillation amplitude multiplying factor.

### PREFERRED MODE FOR CARRYING OUT THE INVENTION

Embodiments of the present disclosure will be described in detail with reference to the drawings. In the description of second and subsequent embodiments, the same components as those of the first embodiment are denoted by the same reference signs, and description thereof is omitted as appropriate.

### FIRST EMBODIMENT

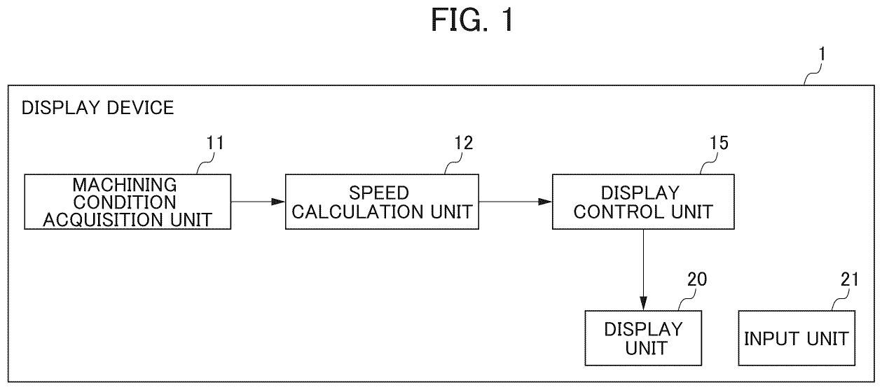

FIG. 1 is a functional block diagram illustrating a display device 1 for a machine tool according to the first embodiment. The display device 1 according to the first embodiment is a computer that displays, on a display unit 20, various kinds of information regarding a machine tool that performs oscillation machining while relatively oscillating a cutting tool and a workpiece. The display device 1 is used, for example, by being connected to a control device (not shown) that is a computer for controlling the machine tool.

The machine tool machines the workpiece with the cutting tool by operating at least one spindle that relatively rotates the cutting tool and the workpiece and at least one feed axis that moves the cutting tool with respect to the workpiece. The machine tool performs various types of machining based on machining programs.

The machine tool can perform oscillation motion in which speeds including forward speed, backward speed, etc. are constantly switched. Alternatively, the machine tool can perform oscillation motion in which the speed changes in a sine curve shape. The following description is provided on the assumption that control for a machine tool of a type a speed of which changes in a sine curve shape is employed.

In the machining by the machine tool according to the present embodiment, the workpiece may have any shape without limitation. Specifically, the present invention is applicable to a case in which a workpiece has a tapered portion or an arc-shaped portion on a surface to be machined and a plurality of feed axes (Z-axis and X-axis) are required, and a case in which a workpiece has a solid cylindrical shape or a hollow cylindrical shape and a specific one feed axis (Z-axis) is sufficient for the machining.

A hardware configuration of the display device 1 for the machine tool will be described. The display device 1 is constituted by, for example, a computer including a memory such as a read only memory (ROM), a random access memory (RAM) and the like, a control processing unit (CPU), and a communication control unit, which are connected to each other via a bus. The display device 1 further includes a display unit 20 that displays various kinds of information, and an input unit 21 through which an operator inputs various kinds of information. The display unit 20 is constituted by, for example, a display that displays various kinds of information. The input unit 21 is, for example, an operation means such as a touch panel, a keyboard, or a button.

The display device 1 for a machine tool may be configured as a computer numerical controller (CNC), or may be connected to a host computer (not shown) such as a CNC, a programmable logic controller (PLC), or the like. The host computer may input, in addition to a machining program, machining conditions such as a rotation speed and the like to the display device 1 for a machine tool.

Next, functional units implemented in the display device 1 will be described. The display device 1 includes a machining condition acquisition unit 11, a speed calculation unit 12, and a display control unit 15 as the functional units. The functional units of the display device 1 are implemented by cooperation between the CPU, the memory, and a control program stored in the memory.

The machining condition acquisition unit 11 is a machining condition acquisition function of acquiring machining conditions for performing the oscillation machining. For example, the machining conditions may be inputted to the display device 1 by an operator through the input unit 21 or an external computer in accordance with information displayed on the display unit 20 of the display device 1, or may be automatically acquired from a machining program, a setting parameter of the machine tool, or the like.

The machining conditions include information necessary for the machining, such as a rotation number (1/min) of the spindle, a feed amount (mm/rev) per rotation of the spindle, a workpiece diameter (mm), a command position of a feed axis, and oscillation conditions. The feed amount (mm/rev) per rotation of the spindle may be calculated from a combination of the rotation number (1/min) of the spindle and a feed speed (mm/min) of the cutting tool.

The oscillation conditions included in the machining conditions will be described next. The oscillation conditions include, as information for uniquely specifying an oscillation waveform, at least a frequency parameter that is information regarding an oscillation frequency of the cutting tool or the workpiece and an amplitude parameter that is information regarding an oscillation amplitude of the cutting tool or the workpiece. The frequency parameter may be an oscillation frequency per relative rotation of the cutting tool and the workpiece, or may be an oscillation frequency per unit time. Alternatively, the frequency parameter may be a cycle parameter of forward/backward motion. The amplitude parameter may be information regarding an oscillation amplitude with respect to a feed amount per relative rotation of the cutting tool and the workpiece, or may be a distance parameter of forward/backward motion. The cycle parameter of forward/backward motion and the distance parameter of forward/backward motion may be determined from a forward speed, a backward speed, a forward motion distance, a backward motion distance, a rotation number of the spindle, a control cycle, and the like. The frequency parameter and the amplitude parameter may be determined from the rotation number of the spindle, a feed speed per rotation, a feed speed per minute, a frequency multiplying factor that is an oscillation frequency per relative rotation of the cutting tool and the workpiece, an amplitude multiplying factor that is an oscillation amplitude with respect to a feed amount per relative rotation of the cutting tool and the workpiece, and the like.

In the present embodiment, an oscillation frequency f (Hz) per rotation of the spindle and an oscillation frequency multiplying factor I (times) are used as parameters of the frequency. The oscillation frequency multiplying factor I (times) may be directly specified, or may be calculated from an oscillation frequency (Hz) and a spindle rotation number S (1/min) after specifying the oscillation frequency (Hz).

An oscillation amplitude A (mm) with respect to the magnitude of a feed amount per rotation of the spindle and an oscillation amplitude multiplying factor K (times) indicating the magnitude of an oscillation amplitude are used as the amplitude parameter. The oscillation amplitude multiplying factor K (times) may also be specified directly.

The speed calculation unit 12 is a speed calculation function of calculating a feed speed of the feed axis in oscillation motion, based on the machining conditions. The speed calculation unit 12 calculates the feed speed using at least the frequency parameter and the amplitude parameter included in the machining conditions.

The speed calculation unit 12 according to the present embodiment calculates a speed that changes due to the oscillation motion, based on at least the frequency parameter and the amplitude parameter. In this example, the speed calculated by the speed calculation unit 12 is a speed of actual motion, such as a speed in the case of superimposition of the oscillation motion on a constant feed. In addition, the speed that changes due to the oscillation motion includes a minimum speed and a maximum speed that are within a calculated speed.

The display control unit 15 is a display control function of displaying, on the display unit 20, various kinds of information related to the display device 1 and information regarding a result of an input by the operator. The display control unit 15 performs display control to display an image based on the minimum feed speed calculated by the speed calculation unit 12 on the display unit 20. The display control unit 15 can perform display control to display the maximum feed speed calculated by the speed calculation unit 12 on the display unit 20 together with the minimum speed.

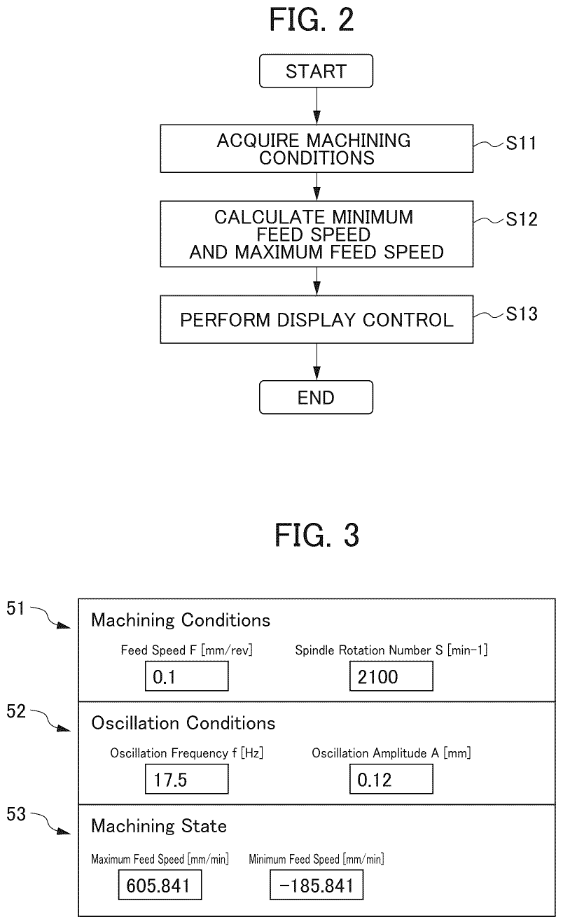

Next, a flow of a process of display control will be described with reference to FIG. 2. FIG. 2 is a flowchart illustrating an example of the flow of a process of display control performed by the display device 1 according to the first embodiment. The order and contents of the process steps illustrated in the flowchart are merely examples, and the order and contents of the process steps can be appropriately changed.

First, the machining condition acquisition unit 11 acquires machining conditions from an input by an operator, parameters of a machining program, or parameters of the machine tool (Step S11). The machining conditions acquired by the machining condition acquisition unit 11 include, for example, a feed speed F (mm/rev) indicating a feed amount, a spindle rotation number S (min⁻¹), an oscillation frequency f (Hz) or an oscillation frequency multiplying factor I (times) as a frequency parameter, an oscillation amplitude A (mm) or an oscillation amplitude multiplying factor K (time) as an oscillation parameter, and the like.

Next, the speed calculation unit 12 calculates a minimum feed speed and a maximum feed speed based on the machining conditions acquired by the machining condition acquisition unit 11 (Step S12). In this example, the speed calculation unit 12 calculates the minimum feed speed and the maximum feed speed based on the frequency parameter and the amplitude parameter included in the machining conditions.

An example in which the speed calculation unit 12 calculates the feed speeds by using the oscillation frequency f (Hz) as the frequency parameter and the oscillation amplitude A (mm) as the amplitude parameter will be described. In this case, the speed calculation unit 12 calculates the minimum feed speed in accordance with the following Expression (1) and calculates the maximum feed speed in accordance with the following Expression (2).

$$[ Expression 1 ]$$

$$FS - 60 π AF [ mm / min ] \qquad Expression ( 1 )$$

$$[ Expression 2 ]$$

$$FS + 60 π AF [ mm / min ] \qquad Expression ( 2 )$$

Another example in which the speed calculation unit 12 calculates the feed speeds by using the oscillation frequency multiplying factor I (times) as the frequency parameter and the oscillation amplitude multiplying factor K (times) as the amplitude parameter will be described. In this case, the speed calculation unit 12 calculates the minimum feed speed in accordance with the following Expression (3) and calculates the maximum feed speed in accordance with the following Expression (4).

$$[ Expression 3 ]$$

$$FS - FKIS π [ mm / min ] \qquad Expression ( 3 )$$

$$[ Expression 4 ]$$

$$FS + FKIS π [ mm / min ] \qquad Expression ( 4 )$$

Next, the display control unit 15 performs display control for displaying an image containing the minimum feed speed and the maximum feed speed calculated by the speed calculation unit 12 on the display unit 20 (Step S13). In the present embodiment, the display control unit 15 displays the minimum feed speed and the maximum feed speed on the same display screen of the display unit 20.

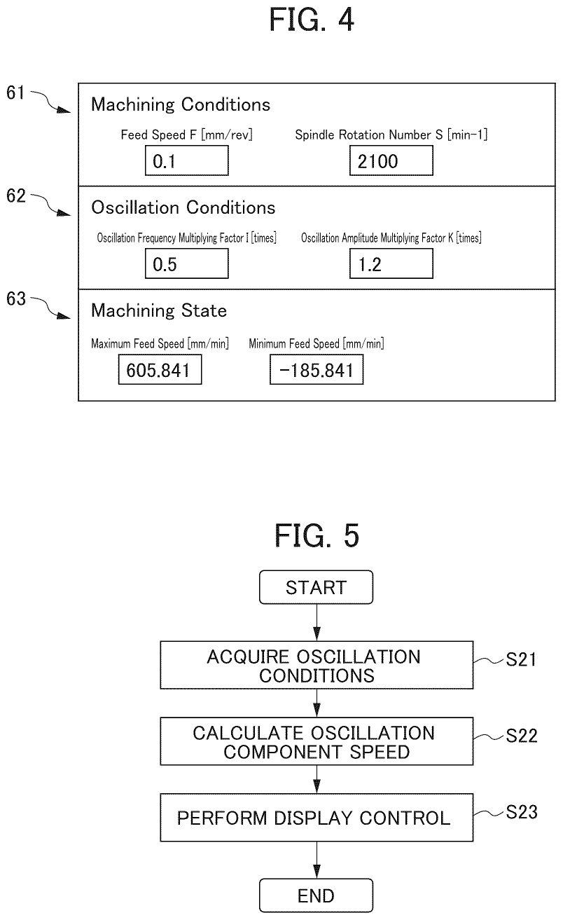

The images displayed on the display unit 20 by the display control unit 15 will be described with reference to FIGS. 3 and 4.

FIG. 3 is a diagram illustrating an example of the image that is displayed on the display unit 20 by the display device 1 and that shows the minimum feed speed and the maximum feed speed based on the oscillation frequency f and the oscillation amplitude A. The image illustrated in FIG. 3 includes a machining condition display field 51, an oscillation condition display field 52, and a machining state display field 53.

In the machining condition display field 51, the feed speed F and the spindle rotation number S are displayed as contents indicating the machining conditions. In the oscillation condition display field 52, the oscillation frequency f and the oscillation amplitude A are displayed as contents indicating the oscillation conditions included in the machining conditions. In the machining state display field 53, the minimum feed speed F as a result of calculation in accordance with Expression (1) by the speed calculation unit 12 and the maximum feed speed F as a result of calculation in accordance with Expression (2) by the speed calculation unit 12 are displayed.

FIG. 4 is a diagram illustrating an example of an image that is displayed on the display unit by the display device 1 and that shows the minimum feed speed and the maximum feed speed based on the oscillation frequency multiplying factor I and the oscillation amplitude multiplying factor K. The image illustrated in FIG. 4 includes a machining condition display field 61, an oscillation condition display field 62, and a machining state display field 63.

In the machining condition display field 61, the feed speed F that is a feed amount, and the spindle rotation number S are displayed as contents indicating the machining conditions. In the oscillation condition display field 62, the oscillation frequency multiplying factor I and the oscillation amplitude multiplying factor K are displayed as contents indicating the oscillation conditions included in the machining conditions. In the machining state display field 63, the minimum feed speed F as a result of calculation in accordance with Expression (3) by the speed calculation unit 12 and the maximum feed speed F as a result of calculation in accordance with Expression (4) by the speed calculation unit 12.

The display device 1 for a machine tool according to the first embodiment, which performs oscillation machining while relatively oscillating a cutting tool and a workpiece, exerts the following effects.

The display device 1 for a machine tool according to the present embodiment includes: the machining condition acquisition unit 11 that acquires at least a frequency parameter and an amplitude parameter as machining conditions for performing the oscillation machining; the speed calculation unit 12 that calculates a minimum feed speed that is the minimum included in a speed that changes due to oscillation motion, based on at least the frequency parameter and the amplitude parameter; and the display control unit 15 that displays, on the display unit 20, an image based on the minimum feed speed.

Due to this feature, the minimum feed speed relating to a degree of a problem caused by return motion or the like is automatically calculated based on the machining conditions and is displayed on the display unit 20. As a result, the operator can easily grasp the degree of the problem caused by the return motion.

Furthermore, in the present embodiment, the speed calculation unit 12 further calculates a maximum feed speed that is the maximum included in the speed that changes due to the oscillation motion, based on at least the frequency parameter and the amplitude parameter, and the display control unit 15 displays the minimum feed speed and the maximum feed speed on the same display unit 20. Due to this feature, in which the maximum feed speed is automatically calculated and displayed in addition to the minimum feed speed, the operator can easily grasp a fluctuation range (rough transition) of the speed during the oscillation machining. There is a case in which a recommended feed speed is set for each tool or each workpiece. In this regard, since the feature of the present embodiment allows the operator to grasp the fluctuation range of the speed, the operator can easily check whether the transition of the feed speed falls within the recommended range.

### SECOND EMBODIMENT

Next, a display device 1 according to a second embodiment that performs display control different from that of the display device 1 according to the first embodiment will be described. The display device 1 of the second embodiment has a configuration similar to that of the first embodiment. The second embodiment is different from the first embodiment in that a speed calculation unit 12 of the second embodiment calculates a minimum feed speed as an oscillation component speed.

FIG. 5 is a flowchart illustrating an example of a flow of a process of display control performed by the display device according to the second embodiment. In the second embodiment, a machining condition acquisition unit 11 acquires oscillation conditions from an input by an operator, parameters of a machining program, or parameters of a machine tool (Step S21). The oscillation conditions acquired by the machining condition acquisition unit 11 include, for example, an oscillation frequency f (Hz) or an oscillation frequency multiplying factor I (times) as a frequency parameter, an oscillation amplitude A (mm) or an oscillation amplitude multiplying factor K (times) as an oscillation parameter, and the like. In the case of acquiring the oscillation frequency multiplying factor I (times) and the oscillation amplitude multiplying factor K (times) as the oscillation conditions, the machining condition acquisition unit 11 further acquires a feed speed F (mm/rev) as a reference feed speed and a spindle rotation number S (min⁻¹).

Next, the speed calculation unit 12 calculates the oscillation component speed based on the oscillation conditions acquired by the machining condition acquisition unit 11 (Step S22). For example, in a case where a machine tool to be controlled by means of the display device 1 performs cutting involving oscillation in a mode in which an oscillation component is superimposed on a constant feed, the speed calculation unit 12 calculates the speed of the oscillation component itself to be superimposed as the oscillation component speed. In this example, the speed calculation unit 12 calculates the oscillation component speed based on the frequency parameter and the amplitude parameter included in the oscillation conditions.

An example in which the speed calculation unit 12 calculates the oscillation component speed by using the oscillation frequency f (Hz) as the frequency parameter and the oscillation amplitude A (mm) as the amplitude parameter will be described. In this example, the speed calculation unit 12 calculates the absolute value of a maximum oscillation component speed included in the absolute value of a speed that changes due to the oscillation motion, in accordance with the following Expression (5). In the present embodiment, due to adoption of a configuration in which the speed fluctuates in a sine curve shape, the maximum positive value and the maximum negative value of the oscillation component speed have the same absolute value. Even in a configuration in which the oscillation component speed fluctuates in a triangular waveform, the present embodiment is also applicable to a case where the maximum positive value and the maximum negative value included in an oscillation component speed that changes due to the oscillation motion have the same absolute value.

$$[ Expression 5 ]$$

$$60 π AF [ mm / min ] \qquad Expression ( 5 )$$

Next, another example in which the speed calculation unit 12 calculates the oscillation component speed by using the oscillation frequency multiplying factor I (times) as the frequency parameter and the oscillation amplitude multiplying factor K (times) as the amplitude parameter will be described. In this case, the speed calculation unit 12 calculates the absolute value of a maximum oscillation component speed included in the absolute value of a speed that changes due to the oscillation motion, in accordance with the following Expression (6), and calculates a maximum feed speed in accordance with Expression (6).

$$[ Expression 6 ]$$

$$FKIS π [ mm / min ] \qquad Expression ( 6 )$$

Next, a display control unit 15 performs display control for displaying an image containing the oscillation component speed calculated by the speed calculation unit 12 on the display unit 20 (Step S23). In the present embodiment, the display control unit 15 displays the absolute value of the oscillation component speed on the same display screen of the display unit 20.

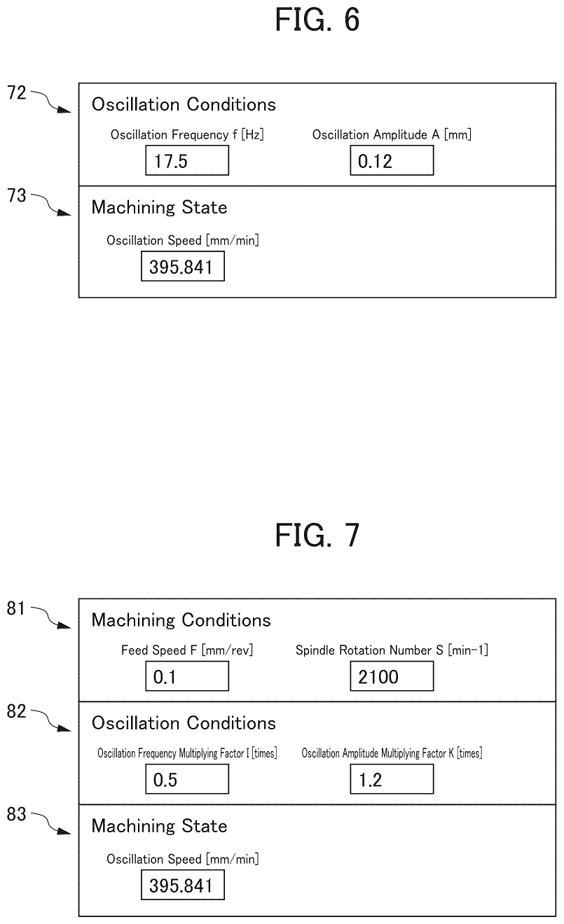

The images displayed on the display unit 20 by the display control unit 15 will be described with reference to FIGS. 6 and 7,

FIG. 6 is a diagram illustrating an example of the image that is displayed on a display unit 20 by the display device 1 and that shows an oscillation component speed based on the oscillation frequency f and the oscillation amplitude A. The image illustrated in FIG. 6 includes an oscillation condition display field 72 and a machining state display field 73. In the oscillation condition display field 72, the oscillation frequency f and the oscillation amplitude A are displayed as contents indicating the oscillation conditions. In the machining state display field 73, the oscillation component speed as a result of the calculation in accordance with Expression (5) by the speed calculation unit 12 is displayed.

FIG. 7 is a diagram illustrating an example of the image that is displayed on the display unit 20 by the display device 1 and shows an oscillation component speed based on the oscillation frequency multiplying factor and the oscillation amplitude multiplying factor. The image illustrated in FIG. 7 includes a machining condition display field 81, an oscillation condition display field 82, and a machining state display field 83.

In the machining condition display field 81, the feed speed F that is a reference feed speed as well, and the spindle rotation number S are displayed as contents indicating the machining conditions. In the oscillation condition display field 82, the oscillation frequency multiplying factor I and the oscillation amplitude multiplying factor K are displayed as contents indicating the oscillation conditions included in the machining conditions. In the machining state display field 63, the oscillation component speed as a result of calculation in accordance with Expression (6) by the speed calculation unit 12 is displayed in the form of the absolute value.

As described above, in the second embodiment, the speed calculation unit 12 calculates the minimum feed speed as the oscillation component speed (e.g., the oscillation speed in the machining state display field 73 illustrated in FIG. 6 or the oscillation speed in the machining state display field 83 illustrated in FIG. 7) excluding the component of a reference feed speed that is constant and serves as the reference of oscillation motion. This feature makes it possible for the operator to grasp, in more detail, a degree of a problem caused by the return motion or the like due to the oscillation component speed.

In the second embodiment, the display control unit 15 displays the oscillation component speed in the form of the absolute value. In a case where the minimum speed and the maximum speed are equal to each other, this feature makes it possible to express the speed fluctuation range between the maximum value and the minimum value only by displaying the absolute value. As a result, the display cost can be reduced as compared with a case where the minimum feed speed and the maximum feed speed are both displayed.

In addition, in the second embodiment, the machining condition acquisition unit 11 acquires a reference feed speed that is constant and serves as a reference of oscillation motion, and the display control unit 15 displays the oscillation component speed and the reference feed speed (e.g., the feed speed in the machining condition display field 81 illustrated in FIG. 7) on the same display unit 20. This feature makes it possible for the operator not only to easily grasp the maximum speed and the minimum speed of actual motion based on both the oscillation component speed and the reference feed speed, but also to grasp, in more detail, a fluctuation range of the speed in the oscillation machining and a degree of a problem caused by the return motion, while reducing the display cost.

It should be noted that the method of calculating the oscillation component speed is not limited to the method according to the above embodiment. In the case where the machine tool to be controlled by means of the display device 1 performs cutting involving oscillation by controlling an actual forward speed and an actual backward speed, the speed calculation unit 12 may calculate a reference feed speed that is constant and serves as a reference from an average value of the total of the forward speed and the backward speed, and may calculate the oscillation component speed by subtracting the constant reference feed speed.

Furthermore, in the second embodiment, the oscillation component speed is displayed in the form of the absolute value, but the present invention is not limited to this configuration. For example, the oscillation component speed may be displayed as a minimum feed speed, or the oscillation component speed with a positive or negative sign may be displayed as the minimum feed speed or the maximum feed speed.

In the second embodiment, the example in which the oscillation component speed as the minimum feed speed and the maximum feed speed are displayed has been described, but a value that is changed in real time in accordance with actual oscillation machining may be additionally displayed.

It should be noted that the present disclosure is not limited to the above-described embodiments and variations, and modifications and improvements within a range in which the object of the present disclosure can be achieved are encompassed in the present disclosure.

The following further discloses additional remarks regarding the foregoing embodiments and variations thereof.

### (Additional Remark 1)

A display device (1) for a machine tool that performs oscillation machining while relatively oscillating a cutting tool and a workpiece, the display device (1) including: a machining condition acquisition unit (11) that acquires at least a frequency parameter and an amplitude parameter as machining conditions for performing the oscillation machining; a speed calculation unit (12) that calculates a minimum feed speed that is a minimum included in a speed that changes due to oscillation motion, based on at least the frequency parameter and the amplitude parameter; and a display control unit (15) that displays, on a display unit (20), an image based on the minimum feed speed.

### (Additional Remark 2)

In the display device (1), the speed calculation unit (12) further calculates a maximum feed speed that is a maximum included in the speed that changes due to the oscillation motion, based on at least the frequency parameter and the amplitude parameter, and the display control unit (15) displays the minimum feed speed and the maximum feed speed on the same display unit (20).

### (Additional Remark 3)

In the display device (1),
the speed calculation unit (12) calculates the minimum feed speed as an oscillation component speed excluding a component of a reference feed speed that is constant and serves as a reference of oscillation motion.

### (Additional Remark 4)

In the display device (1),
the display control unit (15) displays the oscillation component speed in the form of an absolute value.

### (Additional Remark 5)

In the display device (1),
the machining condition acquisition unit (11) acquires the reference feed speed that is constant and serves as the reference of oscillation motion, an the display control unit (15) displays the oscillation component speed and the reference feed speed on the same display unit (20).

### (Additional Remark 6)

A display device (1) for a machine tool that performs oscillation machining while relatively oscillating a cutting tool and a workpiece by superimposing, on a constant feed, an oscillation command for sine curve-shaped oscillation or an oscillation command for triangular wave-shaped oscillation in which a minimum feed speed and a maximum feed speed included in a speed that changes are the same, the display device (1) including:
a machining condition acquisition unit (11) that acquires at least a frequency parameter and an amplitude parameter as machining conditions for performing the oscillation machining; a speed calculation unit (12) that calculates a maximum absolute value speed that is a maximum included in an absolute value of a speed that changes and pertains to the oscillation command, based on at least the frequency parameter and the amplitude parameter; and
a display control unit (15) that displays, on a display unit, an image based on the maximum absolute value speed.

### (Additional Remark 7)

In the display device (1) according to Additional Remark 6,
the machining condition acquisition unit (11) acquires a reference feed speed that is constant and serves as a reference of oscillation motion, and
the display control unit (15) displays an oscillation component speed excluding a component of the reference feed speed, and the reference feed speed on the display unit (20).

### EXPLANATION OF REFERENCE NUMERALS

1: Display device for machine tool
11: Machining condition acquisition unit
12: Speed calculation unit
15: Display control unit
20: Display unit

1. A display device for a machine tool that performs oscillation machining while relatively oscillating a cutting tool and a workpiece, the display device comprising:
a machining condition acquisition unit that acquires at least a frequency parameter and an amplitude parameter as machining conditions for performing the oscillation machining;
a speed calculation unit that calculates a minimum feed speed that is a minimum included in a speed that changes due to oscillation motion, based on at least the frequency parameter and the amplitude parameter; and
a display control unit that displays, on a display unit, an image based on the minimum feed speed.

2. The display device according to claim 1, wherein
the speed calculation unit further calculates a maximum feed speed that is a maximum included in the speed that changes due to the oscillation motion, based on at least the frequency parameter and the amplitude parameter, and
the display control unit displays the minimum feed speed and the maximum feed speed on the display unit.

3. The display device according to claim 1, wherein
the speed calculation unit calculates the minimum feed speed as an oscillation component speed excluding a component of a reference feed speed that is constant and serves as a reference of oscillation motion.

4. The display device according to claim 3, wherein
the display control unit displays the oscillation component speed in a form of an absolute value.

5. The display device according to claim 3, wherein
the machining condition acquisition unit acquires the reference feed speed that is constant and serves as the reference of oscillation motion, and
the display control unit displays the oscillation component speed and the reference feed speed on the display unit.

6. A display device for a machine tool that performs oscillation machining while relatively oscillating a cutting tool and a workpiece by superimposing, on a constant feed, an oscillation command for sine curve-shaped oscillation or an oscillation command for triangular wave-shaped oscillation in which a minimum feed speed and a maximum feed speed included in a speed that changes are the same, the display device comprising:
a machining condition acquisition unit that acquires at least a frequency parameter and an amplitude parameter as machining conditions for performing the oscillation machining;
a speed calculation unit that calculates a maximum absolute value speed that is a maximum included in an absolute value of a speed that changes and pertains to the oscillation command, based on at least the frequency parameter and the amplitude parameter; and
a display control unit that displays, on a display unit, an image based on the maximum absolute value speed.

7. The display device according to claim 6, wherein
the machining condition acquisition unit acquires a reference feed speed that is constant and serves as a reference of oscillation motion, and
the display control unit displays an oscillation component speed excluding a component of the reference feed speed, and the reference feed speed on the display unit.
